(19) United States
(12) Patent Application Publication
(10) Pub. No.: US 2007/0217327 A1
(43) Pub. Date: Sep. 20, 2007

(54) A METHOD FOR SIGNAL PROCESSING AND A SIGNAL PROCESSOR IN AN OFDM SYSTEM

(75) Inventors: Constant Paul Marie Jozef Baggen, Eindhoven (NL); Sri Andari Husen, Eindhoven (NL); Maurice Leonardus Anna Stassen, Eindhoven (NL); Hoi Yip Tsang, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,594

(22) PCT Filed: May 24, 2005
(86) PCT No.: PCT/IB05/51684

§ 371 Date: Nov. 27, 2006

(30) Foreign Application Priority Data
May 28, 2004 (EP) 04102371.4

(51) Int. Cl. H04J 11/00

(52) U.S. Cl. 370/208

(57) ABSTRACT

A method of signal processing for a receiver for OFDM encoded digital signals. The OFDM encoded digital signals are transmitted as data symbol sub-carriers in several frequency channels. A subset of the sub-carriers is in the form of pilot sub-carriers having a pilot value (aₚ) known to the receiver. First, a received signal (y₀) is obtained, followed by a first estimation of a pilot channel transfer function (H₀)at pilot sub-carriers from said received signal (y₀) and said known pilot values (aₚ). Then a second estimation of a channel transfer function (H₁) is performed at all sub-carriers from said pilot channel transfer function (H₀). A third estimation of a derivative (H′1) of the channel transfer function (H₁) is performed from the channel transfer function (H₁) and a channel transfer function (H₃) from a past OFDM symbol. Finally, a fourth estimation of a cleaned received signal (y₁) is performed from said derivative (H′₁), said received signal (y₀) and said pilot values (aₚ) by removal of pilot-induced interference.

The present invention relates to a method of signal processing for a receiver for encoded digital signals in a wireless communication system and a corresponding signal processor.

The invention further relates to a receiver that is arranged to receive OFDM encoded digital signals and to a mobile device comprising such receiver. The invention relates also to a telecommunication system comprising such mobile device. The method may be used for deriving improved channel coefficients in a system using OFDM technique with pilot sub-carriers, such as a terrestrial video broadcasting system DVB-T. A mobile device can e.g. be a portable TV, a mobile phone, a personal digital assistant, a portable computer such as a laptop or any combination thereof.

In wireless systems for the transmission of digital information, such as voice and video signals, orthogonal frequency division multiplexing technique (OFDM) has been widely used. OFDM may be used to cope with frequency-selective fading radio channels. Interleaving of data may be used for efficient data recovery and use of data error correction schemes.

OFDM is today used in for example the Digital Audio Broadcasting (DAB) system Eureka 147 and the Terrestrial Digital Video Broadcasting system (DVB-T). DVB-T supports 5-30 Mbps net bit rate, depending on modulation and coding mode, over 8 MHz bandwidth. For the 8K mode, 6817 sub-carriers (of a total of 8192) are used with a sub-carrier spacing of 1116 Hz. OFDM symbol useful time duration is 896 μs and OFDM guard interval is ¼, ⅛, 1/16 or 1/32 of the time duration.

However, in a mobile environment, such as a car or a train, the channel transfer function as perceived by the receiver varies as a function of time. Such variation of the transfer function within an OFDM symbol may result in inter-carrier interference, ICI, between the OFDM sub-carriers, such as a Doppler broadening of the received signal. The inter-carrier interference increases with increasing vehicle speed and makes reliable detection above a critical speed impossible without countermeasures.

A signal processing method is previously known from WO 02/067525, WO 02/067526 and WO 02/067527, in which a signal a as well as a channel transfer function H and the time derivative thereof H′ of an OFDM symbol are calculated for a specific OFDM symbol under consideration.

Moreover, U.S. Pat. No. 6,654,429 discloses a method for pilot-added channel estimation, wherein pilot symbols are inserted into each data packet at known positions so as to occupy predetermined positions in the time-frequency space. The received signal is subject to a two-dimensional inverse Fourier transform, two-dimensional filtering and a two-dimensional Fourier transform to recover the pilot symbols so as to estimate the channel transfer function.

An object of the present invention is to provide a method for signal processing which is less complex.

Another object of the invention is to provide a method for signal processing for estimation of a channel transfer function, which uses a Wiener filtration technique and is efficient.

A further object of the present invention is to provide a method for signal processing for estimation of a channel transfer function, in which the estimation is further improved by removal of pilot-induced interference.

These and other objects are met by a method of processing OFDM encoded digital signals, wherein said OFDM encoded digital signals are transmitted as data symbol sub-carriers in several frequency channels, a subset of said sub-carriers being pilot sub-carriers having a known pilot value. The method comprises obtaining a received signal. Then a first estimation is performed of a pilot channel transfer function at pilot sub-carriers from said received signal and said known pilot values, followed by a second estimation of a channel transfer function at all sub-carriers from said pilot channel transfer function, for example using a Wiener filter. A third estimation of a derivative of said channel transfer function is performed from said channel transfer function and a channel transfer function from a past or a future OFDM symbol. Finally, a fourth estimation of a cleaned signal is performed from said derivative, said received signal and said pilot values by removal of pilot-induced interference. In this way, a better estimation is obtained.

The method may furthermore comprise fifth estimation of data values from said cleaned signal and said channel transfer function, sixth estimation of a second received signal from said cleaned signal, said derivative and said data estimation, by removal of inter-carrier interference (ICI), seventh estimation of a pilot channel transfer function at pilot positions from said second received signal and said pilot values, and eight estimation of the channel transfer function at all sub-carriers.

In an alternative embodiment of the invention, the fourth estimation is performed by removing pilot-induced interference from only a subset of sub-carriers, called partial pre-removal of pilot-induced interference. In this way, the calculations may be reduced further without loosing much in efficiency.

In the second, third and eight estimation, Wiener filters may be used, such as FIR filters having pre-computed filter coefficients.

In another aspect of the invention, there is provided a signal processor for a receiver for OFDM encoded digital signals, for performing the above-mentioned method steps.

Further objects, features and advantages of the invention will become evident from a reading of the following description of an exemplifying embodiment of the invention with reference to the appended drawings, in which:

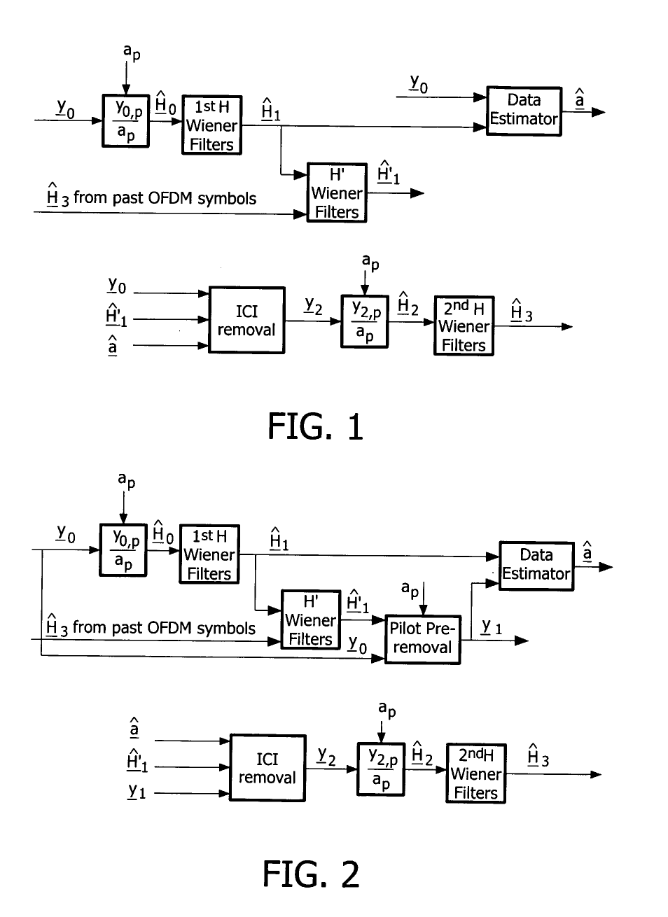

FIG. 1 is a schematic block diagram showing a signal processing method in which the invention may be used.

FIG. 2 is a schematic block diagram similar to FIG. 1 showing the application of the present invention.

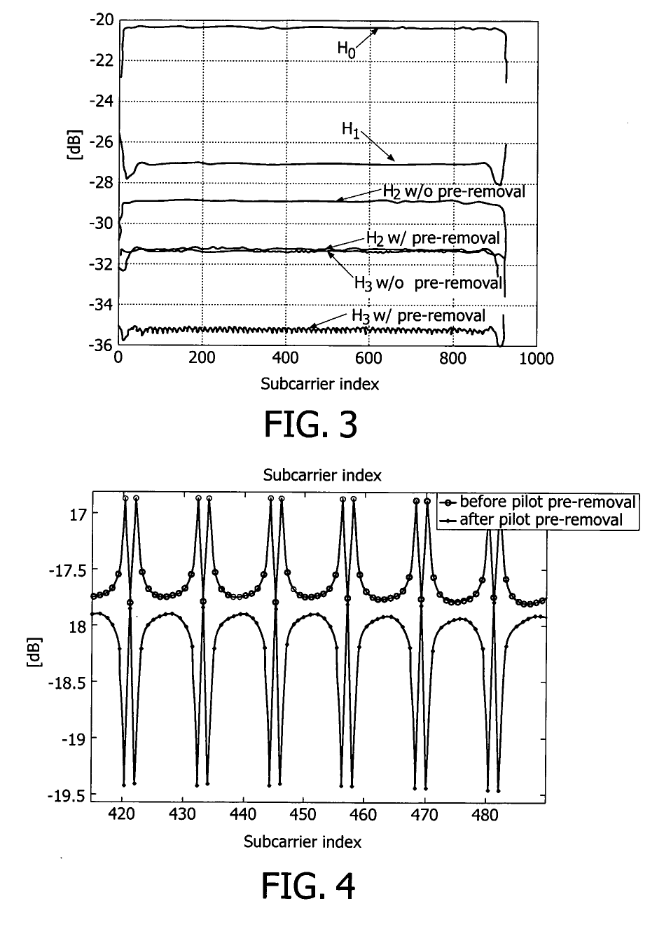

FIG. 3 is a graphical diagram showing the effect of the present intention according to FIG. 2.

FIG. 4 is a graphical diagram showing the effect in an enlarged scale.

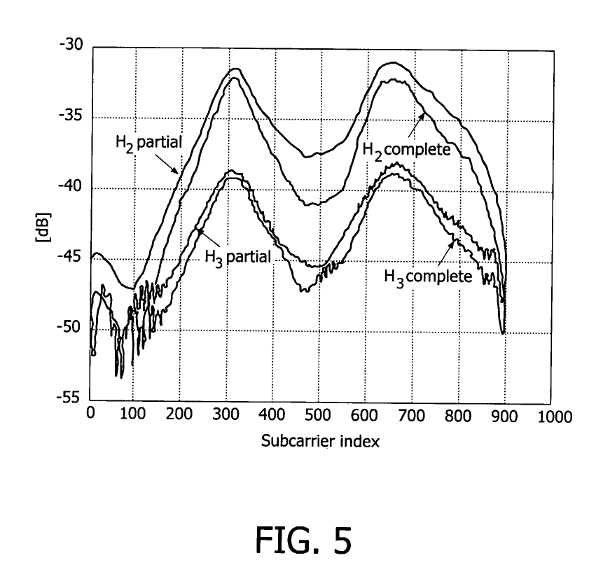

FIG. 5 is a graphical diagram showing the improvement according to the invention over different sub-carrier index.

In interference-limited system, iterative channel estimation or iterative data estimation utilizing interference cancellation/suppression is commonly used in order to obtain better estimates. In these schemes, in addition to interference cancellation, errors are introduced into the signal, mainly due to the data estimation error. If some sources of interferences are known to the receiver (i.e. training or pilot symbols), the cancellation of these pilot-induced interferences from the received signal can be performed as soon as the cross-talk/coupling coefficients are obtained. The pilot pre-removal removes these interferences prior to data estimation. This approach is particularly advantageous when the iterative channel estimation scheme with Wiener filtering is used, because it will ensure that the errors introduced at the pilots are uncorrelated with the pilots.

A doubly-selective channel in an OFDM system (e.g. in the case of the reception of DVB-T signal in a fast moving vehicle) can be modeled as to consist of a static channel frequency response and a non-static channel frequency response, which gives the variation of the frequency response within one OFDM symbol. If the channel varies slowly within one symbol, we can take into account only the first order variation as following:
y=diag{H}a+Ξdiag{H′}a+n (1)
with y being the received vector (with N sub-carriers), a the transmitted vector, H the static frequency response, H′ the first order variation of the frequency response, and Ξ the fixed leakage (or coupling) matrix and n is the additive white Gaussian noise.

There are different ways of estimating the above channel parameters, i.e. H and H′. One of them is the iterative channel estimation using Wiener filtering which is shown in FIG. 1. The idea of the scheme is to use a received signal whose Inter-Carrier Interference (ICI) has been suppressed in order to gain better channel parameter estimation. This is achieved in the following way. First, raw estimates of H at pilot positions Ĥ₀ is obtained from the known pilot symbols aₚ. Ĥ₀ is then fed into the first H Wiener filters to obtain the first estimate of H Ĥ₁ at all sub-carriers. An estimate of H′ is obtained by feeding Ĥ₁ into the H′ Wiener filters. Ĥ₁ is also fed into data estimator (a one-tap or multi-tap Wiener equalizer) along with the received signal y₀ to obtain the first estimate of data symbols â. Together with Ĥ′₁, â is used for canceling the ICI from y₀. New raw estimates of H at pilot positions Ĥ₂ are made from the ICI-suppressed received signal y₂, and further fed to the second H filters to obtain Ĥ₃.

Simulations show that for a channel with τᵣₘₛ of 1 μs and maximum Doppler frequency of 112 Hz, Ĥ₀ has on average Mean Square Error (MSE) of −20.3 dB. With the 11-tap 1^{st} H Wiener Filters designed to work on the MSE of Ĥ₀, on average the MSE of Ĥ₁ decreases to −27 dB as expected. Because of the ICI removal, the MSE of Ĥ₂ decreases to −28.9 dB. However, with the 11-tap 2^{nd} filters designed accordingly, on average the MSE of Ĥ₃ decreases only to −31.3 dB, while theoretically, it is expected to be −35.5 dB.

However, the interferences experienced by the non-pilots sub-carriers comprise pilot-induced interferences. As a consequence, the symbol estimates from the non-pilots sub-carriers will also contain pilot-induced interferences. When these estimates are used for canceling the interferences contained in the pilots, the pilot-induced interferences are added to the pilots as self-interferences. The self-interferences are correlated to the pilots. Because the 2^{nd} H Wiener filter is designed based on the assumption that the interference and noise are uncorrelated with the wanted signal, the 2^{nd} H Wiener filters can't bring the expected improvement.

A possible solution is to redesign the 2^{nd} H Wiener filtering by taking into account the correlation between the wanted signal H and the self-interferences. However, this approach is not favorable, because the correlation is different for every different channel realization, and therefore the 2^{nd} H Wiener filter must be redesigned every time we have a different channel realization.

According to the present invention, another approach is to avoid self-interferences in pilots by performing what is call pilot pre-removal. The self-interferences can be avoided if the data estimates used for interference cancellation don't contain any pilot-induced interferences. Because the pilot symbols aₚ are known and the H′ has been estimated, it is possible to perform the removal of pilot-induced interferences from the data estimates â. However, it may be easier and more favorable to perform the removal from the received signal y₀ prior to entering the data estimator, as following:
y₁=y₀−Ξdiag{Ĥ′₁}p (2)
with pₖ=aₚ for k equals the pilot index and 0 otherwise. The channel estimation scheme with pilot pre-removal is shown in FIG. 2.

FIG. 3 shows the improvement brought by the pilot pre-removal. We observed that the pilot pre-removal has lowered MSE of Ĥ₃ as well as Ĥ₂ (approximately 2.3 dB), due to the absence of self-interference. The MSE of Ĥ₃ decreases 4.3 dB and the 2^{nd} H wiener filters manage to gain approximately 4.4 dB.

As pilot-induced interferences are strongest in data sub-carriers closest to the pilots, the closest sub-carriers will have lower interference level because of the pilot pre-removal. As a consequence, the qualities of data estimates at the sub-carriers are better. FIG. 4 shows the residual ICI power level before and after pilot pre-removal (i.e. residual ICI power level of y₀ and y₁). The residual ICI power suppression varies between 2.5 dB (at sub-carriers next to the pilots) and 0.1 dB (at the pilots). From simulations for a specific channel realization using perfectly known H′, this suppression decreases the MSE of â 2.5 dB at sub-carriers closest to the pilots, and 0.1 dB at sub-carriers in between two pilots. The improvement in â quality subsequently decreases the ICI level in y₂, particularly at the pilots (approximately 4 dB) and at sub-carriers next to the pilots (1.5-2 dB).

Pilot pre-removal can be done completely or partially. In complete pilot pre-removal (equation (2)), interferences caused by one pilot are completely removed from all other sub-carriers regardless of the strength of the interferences at the sub-carriers. However, this may not be necessary because the pilot-induced interferences, especially those from the faraway pilots, can be significantly small compared to the interferences from the neighboring sub-carriers. Therefore, whether they are removed or not does not really influence the interference level in the sub-carrier. Furthermore, from the channel estimation's point of view, the pilot-induced interferences may need to be removed only from some neighboring sub-carriers, because the self-interferences decay much faster and therefore only those from the closest neighboring sub-carriers are equally dominant with other interferences.

FIG. 5 compares the MSE of Ĥ₂ and Ĥ₃ (on a specific channel realization) with complete pilot pre-removal and partial pilot pre-removal where the pilot-induced interferences are only removed from 5 closest sub-carriers to the left and right of the pilots. We observe that the MSE of Ĥ₂with the partial pre-removal is higher than the one with complete pre-removal, but the differences in MSE are not constant. The differences are due to the pilot-to-pilot interferences, which aren't removed. In the region where the difference is small, the MSE of data estimates is high. The errors caused by ICI removal are more dominant than the remaining pilot-to-pilot interferences. In the region where the difference is large, the MSE of data estimates is low. The significantly reduced errors (due to good data estimates) are less dominant than the pilot-to-pilot interferences.

Despite the differences, we observe that we can still gain significantly from the 2^{nd} Wiener filtering in both cases. Hence, it is not necessary to pre-remove the pilot-induced interferences caused by one pilot from all other sub-carriers in order to gain significantly from the 2^{nd} H Wiener filters. However, as shown in FIG. 5, the remaining pilot-to-pilot interferences can cause the qualities of Ĥ₂ (so as y₂) and Ĥ₃ to be lower.

Complete pilot pre-removal can be implemented as following:
By performing the subtraction of the received vector y₀ from the product of Ξ matrix and the result of element-wise multiplication of Ĥ′₁ and p, which contains the pilots symbols at pilot index, and zeros elsewhere. This mat not be efficient, not only because it requires N(N+1) multiplications (actually for 8k DVB-T, is 6817×6818 multiplications), but also many multiplications are unnecessary. However, these huge computations can be avoided if an FFT-like implementation is used.
Zero multiplications can be omitted by taking the columns of Ξ matrix that correspond to pilot positions and omitting the zeroes from the estimated data vector. The number of multiplications becomes N/12(N+1)(for 8k DVB-T is 568×6818).

The implementation and complexity of partial pilot pre-removal depend on the number of sub-carriers in which interferences from a pilot are removed. If the interferences induced by a pilot are removed from n neighboring sub-carriers, the number of multiplications required is (n+1)N/12.

The different filters and operations may be performed by a dedicated digital signal processor (DSP) and in software. Alternatively, all or part of the method steps may be performed in hardware or combinations of hardware and software, such as ASIC:s (Application Specific Integrated Circuit), PGA (Programmable Gate Array), etc.

It is mentioned that the expression “comprising” does not exclude other elements or steps and that “a” or “an” does not exclude a plurality of elements. Moreover, reference signs in the claims shall not be construed as limiting the scope of the claims.

Herein above has been described several embodiments of the invention with reference to the drawings. A skilled person reading this description will contemplate several other alternatives and such alternatives are intended to be within the scope of the invention. Also other combinations than those specifically mentioned herein are intended to be within the scope of the invention. The invention is only limited by the appended patent claims.

1. A method of processing OFDM encoded digital signals, wherein said OFDM encoded digital signals are transmitted as data symbol sub-carriers in several frequency channels, a subset of said sub-carriers being pilot sub-carriers having a known pilot value (aₚ), comprising
obtaining a received signal (y₀);
estimating first a pilot channel transfer function (H₀) at pilot sub-carriers from said received signal (y₀) and said known pilot values (aₚ);
estimating second a channel transfer function (H₁) at all sub-carriers from said pilot channel transfer function (H₀);
estimating third a derivative (H′₁) of said channel transfer function (H₁) from said channel transfer function (H₁) and a channel transfer function (H₃) from a past or a future OFDM symbol; and
estimating fourth a cleaned signal (y₁) from said derivative (H′₁), said received signal (y₀) and said pilot values (aₚ) by removal of pilot-induced interference.

2. The method of claim 1, further comprising:
estimating fifth data values (a) from said cleaned signal (y1) and said channel transfer function (H₁);
estimating sixth a second received signal (y₂) from said cleaned signal (y₁), said derivative (H′₁) and said data estimation (a), by removal of inter-carrier interference (ICI);
estimating seventh a pilot channel transfer function (H₂) at pilot positions from said second received signal (y₂) and said pilot values (aₚ);
estimating eighth the channel transfer function (H₃) at all sub-carriers.

3. The method of claim 1, wherein said fourth estimation is performed by removing pilot-induced interference from only a subset of sub-carriers.

4. The method of claim 1, wherein said third estimation is Wiener filters.

5. The method of claim 1, wherein said second estimation is Wiener filters.

6. The method of claim 1, wherein said eight estimation is Wiener filters.

7. The method of claim 4, wherein said Wiener filters are FIR filters, having pre-computed filter coefficients.

8. A signal processor arranged to process OFDM encoded digital signals, wherein said OFDM encoded digital signals are transmitted as data symbol sub-carriers in several frequency channels, a subset of said sub-carriers being in the form of pilot sub-carriers having a known pilot value (aₚ), comprising
a received signal (y₀);
a first estimator arranged to estimate a pilot channel transfer function (H₀) at pilot sub-carriers from said received signal (y₀) and said known pilot values (aₚ);
a second estimator arranged to estimate a channel transfer function (H₁) at all sub-carriers from said pilot channel transfer function (H₀);
a third estimator arranged to estimate a derivative (H′₁) of said channel transfer function (H₁) from said channel transfer function (H₁) and a channel transfer function (H₃) from a past OFDM symbol; and
a fourth estimator arranged to estimate a cleaned signal (y₁) from said derivative (H′₁), said received signal (y₀) and said pilot values (aₚ) by removal of pilot-induced interference.

9. A receiver arranged to receive OFDM encoded digital signals, which OFDM encoded digital are transmitted as data symbol sub-carriers in several frequency channels, a subset of said sub-carriers being pilot sub-carriers having a known pilot value (aₚ), comprising:
a received signal (y₀);
a first estimator arranged to estimate a pilot channel transfer function (H₀) at pilot sub-carriers from said received signal (y₀) and said known pilot values (aₚ);
a second estimator arranged to estimate a channel transfer function (H₁) at all sub-carriers from said pilot channel transfer function (H₀);
a third estimator arranged to estimate a derivative (H′₁) of said channel transfer function (H₁) from said channel transfer function (H₁) and a channel transfer function (H₃) from a past OFDM symbol; and
a fourth estimator arranged to estimate a cleaned signal (y₁) from said derivative (H′₁), said received signal (y₀) and said pilot values (aₚ) by removal of pilot-induced interference.

10. A mobile device comprising a receiver according to claim 9.

11. A mobile device arranged to carry out the method according to claim 1.

12. A telecommunication system comprising a mobile device according to claim 13.
